(19) United States
(12) Patent Application Publication
(10) Pub. No.: US 2011/0268532 A1
(43) Pub. Date: Nov. 3, 2011

(54) FASTENING APPARATUS

(75) Inventors: CHIA-KANG WU, Tu-Cheng (TW); LUNG-SHENG TSAI, Tu-Cheng (TW); LI-PING CHEN, Tu-Cheng (TW)

(73) Assignee: HON HAI PRECISION INDUSTRY CO., LTD., Tu-Cheng (TW)

(21) Appl. No.: 12/947,739

(22) Filed: Nov. 16, 2010

(30) Foreign Application Priority Data
Apr. 28, 2010 (CN) 201010158342.8

(51) Int. Cl. F16B 35/00

(52) U.S. Cl. 411/378

(57) ABSTRACT

A fastening apparatus for securing a first component to a second component, includes a fastening anchor and a securing member. The fastening anchor has a mounting hole, and a first inner screw thread is defined in the mounting hole. The fastening anchor is attached to the first component, and the mounting hole is corresponding to a first securing hole of the first component. The securing member includes a shaft, and a protrusion is disposed on the shaft. An outer screw thread is defined on a proximal end of the protrusion, and the outer screw thread corresponds to the first inner screw thread, wherein the shaft of the securing member can pass through the mounting hole and the first securing hole, allowing the protrusion to be engaged with a second securing hole of the second component.

### BACKGROUND

1. Technical Field

The present disclosure relates to fastening apparatuses, and particularly to a mounting apparatus for securing a first component to a second component.

2. Description of Related Art

Fastening apparatuses are usually used to secure two or more components together. A typical fastening apparatus is composed of a male member, such as a screw, and a female member, such as a screw hole. Generally, the male screw includes a head and a threaded body. The female screw defines a threaded hole. A first component defines a first through hole, and a second component defines a second through hole. In use, the male screw shaft inserts through the first through hole and the second through hole. The male screw head abuts against the first component. The male screw external screw thread engages the female screw thread to secure the first component to the second component. However, during manufacturing it is inconvenient and costly to create the threads for the female screw hole in the second component. Therefore there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a fastening apparatus in accordance with an embodiment.

FIG. 2 is an exploded, isometric view of a fastening apparatus, a first component and a second component in accordance with an embodiment.

FIG. 3 is an assembled view of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

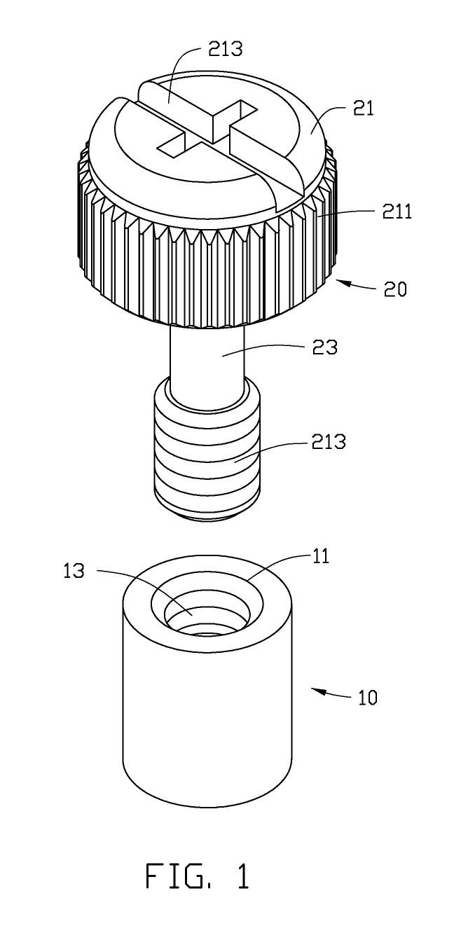

Referring to FIG. 1, a fastening apparatus, in accordance with an embodiment, includes a fastening anchor 10 and a securing member 20 engaged with the fastening anchor 10.

A mounting hole 11 having a first inner screw thread 13 is defined in the center of the fastening anchor 10. In one embodiment, the fastening anchor 10 is a cylinder.

The securing member 20 includes a head 21 and a shaft 23 connected to the head 21. In one embodiment, a diameter of the head 21 is larger than that of the shaft 23. A number of grooves 211 can be defined on the outer surface of the head 21, making it easier to rotate the head 21 by hand. In one embodiment, the grooves 211 are substantially a straight-line. A slot 213 is defined in the center of the top surface of the head 21, configured for receiving a tool (not shown) for rotating the head 21, which rotates the screw. In one embodiment, the slot 213 can accommodate a Phillips and regular screwdriver. It is understood that other types of screw drivers can be used. A protrusion 231 is disposed on the shaft 23, encircled from the center to the end of the shaft 23. The protrusion 231 is capable of being engaged in the mounting hole 11 of the fastening anchor 10. A diameter of the protrusion 231 is larger than that of the shaft 23. An outer screw thread 2311 is defined on the outer surface of the protrusion 231, corresponding to the first inner screw thread 13 of the fastening anchor 10.

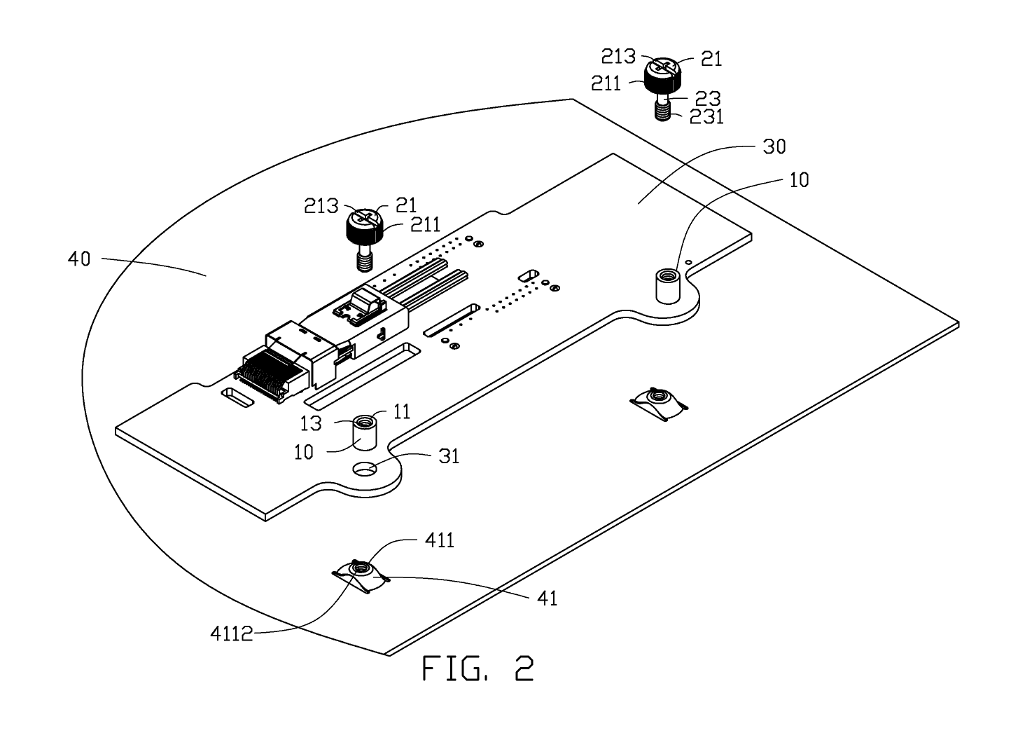

Referring to FIG. 2, the fastening apparatus is provided for securing a first component 30 to a second component 40. The first component 30 may be a printed circuit board, and the second component 40 may be a computer chassis, for example. The first component 30 defines two first securing holes 31. Two bulges 41 protrude from the second component 40. Two second securing holes 411 are defined in the two bulges 41, corresponding to the two first securing holes 31 in the first component 30. A second inner screw thread 4112 is defined in each second securing hole 411.

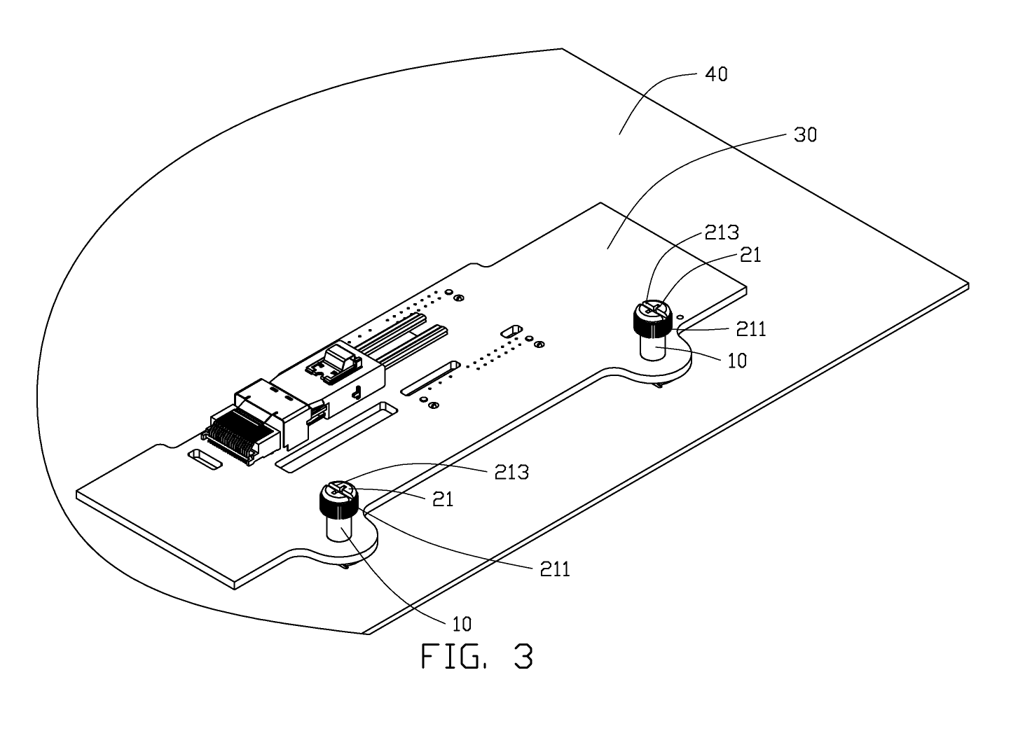

Referring to FIGS. 2-3, in assembly, the first component 30 is placed on the second component 40, and the first securing hole 31 in the first component 30 is aligned with the second securing hole 411 in the second component 40. The fastening anchor 10 is attached to the first securing hole 31 with rivets, and the mounting hole 11 in the fastening anchor 10 is aligned with the first securing hole 31 and the second securing hole 411. The shaft 23 of the securing member 20 is inserted into the mounting hole 11 in the fastening anchor 10. The securing member 20 is rotated by driving the head 21 with the tool inserted into the slot 213, until the protrusion 231 is passed through the first securing hole 31, and screwed into the second securing hole 411. So that the outer screw thread 2311 is engaged with the first inner screw thread 13 in the mounting hole 11 and the second inner screw thread 4112 in the second securing hole 411. Thus, the first component 30 is secured to the second component 40.

In disassembly, the securing member 20 is rotated by turning the head 21 with the tool inserted into the slot 213. The protrusion 231 is in turn disengaged from the second securing hole 411, the first securing hole 31, and the mounting hole 11. Therefore, the first component 30 is removed from the second component 40.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A fastening apparatus configured for securing a first component to a second component, comprising:
a fastening anchor with a mounting hole, a first inner screw thread defined in the mounting hole, the fastening anchor attached to the first component, and the mounting hole corresponding to a first securing hole of the first component; and
a securing member comprising a shaft, a protrusion, having an outer screw thread, disposed on a proximal end of the shaft, and the outer screw thread corresponds to the first inner screw thread;
wherein the shaft of the securing member can pass through the mounting hole and the first securing hole, allowing the protrusion to be engaged with a second securing hole of the second component.

2. The fastening apparatus of claim 1, wherein the securing member comprises a head, and the shaft is connected to the head.

3. The fastening apparatus of claim 2, wherein a diameter of the head is larger than that of the shaft and the fastening anchor.

4. The fastening apparatus of claim 2, wherein a plurality of grooves is located on an outer surface of the head, configured for driving the head rotated easily.

5. The fastening apparatus of claim 4, wherein the plurality of grooves is substantially straight-line.

6. The fastening apparatus of claim 2, wherein a slot is defined in a top surface of the head, configured for receiving a tool for driving the securing member rotated.

7. The fastening apparatus of claim 6, wherein the slot can accommodate a Phillips head screwdriver.

8. The fastening apparatus of claim 1, wherein the fastening anchor is mounted to the first component by riveting.

9. A fastening apparatus configured for securing a first component to a second component, comprising:
a fastening anchor with a mounting hole, the fastening anchor attached to the first component, and the mounting hole corresponding to a first securing hole of the first component; and
a securing member comprising a head and a shaft connected to the head, the shaft having a less diameter than that of the head and the mounting hole, a protrusion disposed on the shaft;
wherein the shaft of the securing member is passed through the mounting hole and the first securing hole, and the head of the securing member is coved on the mounting hole, allowing the protrusion to be engaged with a second securing hole of the second component.

10. The fastening apparatus of claim 9, wherein a first inner screw thread is defined in the mounting hole, and an outer screw thread engaged with the first inner screw thread is defined on the protrusion.

11. The fastening apparatus of claim 9, wherein a plurality of grooves is defined on an outer surface of the head, configured for driving the head rotated easily.

12. The fastening apparatus of claim 11, wherein the plurality of grooves is substantially straight-line.

13. The fastening apparatus of claim 9, wherein a slot is defined in a top surface of the head, to receive a tool for driving the securing member rotated.

14. The fastening apparatus of claim 13 wherein the slot can accommodate a Phillips head screwdriver.

15. The fastening apparatus of claim 9, wherein the fastening anchor is mounted to the first component by riveting.
